(19) United States
(12) Patent Application Publication
(10) Pub. No.: US 2025/0223162 A1
(43) Pub. Date: Jul. 10, 2025

(54) NITROGEN OXIDE DECOMPOSITION CATALYST, CATALYTIC REACTION SYSTEM INCLUDING SAME, AND AIR PURIFICATION DEVICE

(71) Applicants: Samsung Electronics Co., Ltd., Suwon-si (KR); Gwangju Institute of Science and Technology, Gwangju (KR)

(72) Inventors: Su Keun Kuk, Suwon-si (KR); Sung Bong Kang, Gwangju (KR); Hyun Chul Lee, Suwon-si (KR); Wo Bin Bae, Gwangju (KR); Sang Woo Byun, Gwangju (KR); Hyukjae Kwon, Suwon-si (KR); Dongjin Ham, Suwon-si (KR); You Jin Go, Gwangju (KR)

(21) Appl. No.: 18/990,306

(22) Filed: Dec. 20, 2024

(30) Foreign Application Priority Data
Jan. 5, 2024 (KR) 10-2024-0002335

(51) Int. Cl. C01B 21/02; B01D 53/56; B01J 21/02; B01J 21/06; B01J 23/10; B01J 23/42; C01B 13/02

(52) U.S. Cl. CPC C01B 21/02; B01J 21/02; B01J 21/063; B01J 23/10; B01J 23/42; C01B 13/0203; B01D 53/56

(57) ABSTRACT

A nitrogen oxide decomposition catalyst, a catalytic reaction system including the same, and an air purification system, wherein the nitrogen oxide decomposition catalyst includes a heterogenous metal oxide and a first metal disposed on the heterogenous metal oxide and is configured to catalyze a reaction to decompose nitrogen oxides into nitrogen and oxygen.

### CROSS-REFERENCES TO RELATED APPLICATION

This application is based on and claims priority to Korean Patent Application No. 10-2024-0002335, filed on Jan. 5, 2024, in the Korean Intellectual Property Office and all the benefits accruing therefrom under 35 U.S.C. § 119, the content of which is herein incorporated by reference in its entirety.

### BACKGROUND

### 1. Field

The disclosure relates to a nitrogen oxide decomposition catalyst, a catalytic reaction system including the same, and an air purification device.

### 2. Description of the Related Art

Nitrogen oxides, for example, nitrogen monoxide, are representative air pollutants that can cause air pollution issues, such as optical smog and secondary fine dust. Conventional thermal catalyst technologies, such as three-way catalysts (TWCs) or selective catalytic reduction, have been primarily used as nitrogen oxide reduction technologies. However, conventional catalysts can deteriorate with use, causing nitrogen oxides to be converted to nitrous oxide or ammonia, rather than nitrogen (N₂). In addition, the stoichiometric reducing agents used in the systems to achieve denitrification efficiency, may themselves serve as air pollution-causing substances.

As the environmental standards for air pollutant emissions have become stricter in recent years, a more advanced environmental catalyst technology for reducing nitrogen oxides is desirable.

### SUMMARY

Provided are a catalyst for a direct decomposition reaction of nitrogen oxide, a catalytic reaction system including the catalyst, and an air purification system.

Additional aspects will be set forth in part in the description which follows and, in part, will be apparent from the description, or may be learned by practice of the presented embodiments of the present disclosure.

In an aspect, a nitrogen oxide decomposition catalyst includes a heterogenous metal oxide and a first metal disposed on the heterogenous metal oxide. The nitrogen oxide decomposition catalyst is configured to catalyze a reaction to decompose nitrogen oxide into nitrogen and oxygen.

According to another aspect, a catalytic reaction system includes the nitrogen oxide decomposition catalyst.

According to another aspect, an air purification device includes the nitrogen oxide decomposition catalyst.

According to another aspect, a method of manufacturing a nitrogen oxide decomposition catalyst includes combining a precursor including a second metal, a precursor including a third metal, and water to prepare a mixed solution, wherein the precursor of the second metal includes about 0.1 parts by weight to about 40 parts by weight and the precursor of the third metal includes about 0.1 parts by weight to about 40 parts by weight per 100 parts by weight of the solvent; heating the mixed solution in the presence of oxygen to prepare a heterogenous metal oxide; impregnating the heterogenous metal oxide with a precursor of a first metal to provide an impregnated heterogeneous metal oxide; and heating the impregnated heterogenous metal oxide to provide the nitrogen oxide decomposition catalyst.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a three-dimensional schematic diagram illustrating an embodiment of a catalytic reaction system including a nitrogen oxide decomposition catalyst;

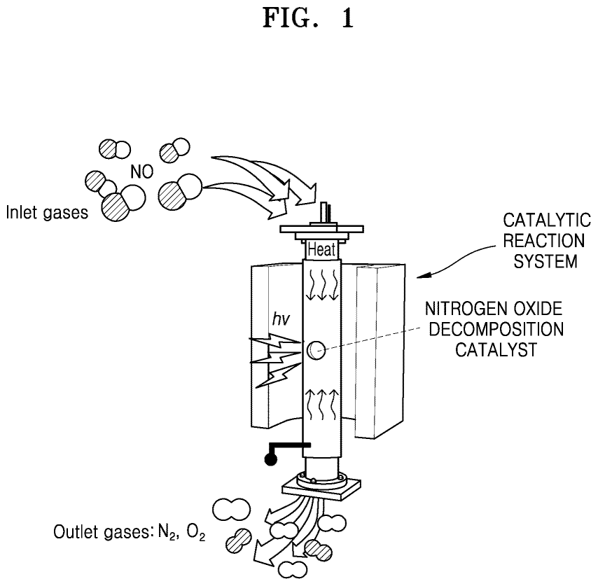

FIG. 2 is a flow diagram illustrating an embodiment of a method of preparing a nitrogen oxide decomposition catalyst;

FIG. 3 is graph illustrating diffraction angle (degrees 2θ) versus intensity (arbitrary units, a.u.) of the X-ray diffraction (XRD) spectra of a nitrogen oxide decomposition catalysts in accordance with Evaluation Example 1;

FIG. 4 is a graph illustrating nitrogen oxide conversion (percent) for nitrogen oxide decomposition catalysts under various thermal conditions in accordance with Evaluation Example 2;

FIG. 5 is a graph illustration nitrogen oxide conversion (percent) for nitrogen oxide decomposition catalysts under photo-thermal conditions in accordance with Evaluation Example 3; and

FIG. 6 is a graph temperature (°C.) versus illustrating intensity (a.u.) of a H₂-temperature programmed reduction (H₂-TPR) analysis of nitrogen oxide decomposition catalysts in accordance with Evaluation Example 4.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

The present inventive concept, which will be more fully described hereinafter, may have various variations and various embodiments, and specific embodiments will be illustrated in the accompanied drawings and described in greater detail. However, the present inventive concept should not be construed as being limited to specific embodiments set forth herein. Rather, these embodiments are to be understood as encompassing all variations, equivalents, or alternatives included in the scope of the present inventive concept.

The terminology used hereinbelow is used for the purpose of describing particular embodiments only, and is not intended to limit the present inventive concept. As used herein, the singular forms are intended to include the plural forms as well, unless the context clearly indicates otherwise. As used herein, the terms “comprises” and/or “comprising,” or “includes” and/or “including” specify the presence of stated features, regions, integers, steps, operations, elements, components, ingredients, materials, or combinations thereof, but do not preclude the presence or addition of one or more other features, regions, integers, steps, operations, elements, components, ingredients, materials, or combinations thereof. As used herein, “/” may be interpreted as “and”, or as “or” depending on the context.

In the drawings, the thicknesses of layers and regions may be exaggerated for clarity of description. Like reference numerals denote like elements throughout the specification. Throughout the specification, when a component, such as a layer, a film, a region, or a plate, is described as being “above” or “on” another component, the component may be directly above the another component, or there may be yet another component therebetween. It will be understood that although the terms “first,” “second,” and “third,” etc. may be used herein to describe various elements, these elements should not be limited by these terms. These terms are only used to distinguish one element from another element.

The terminology used herein is for the purpose of describing particular embodiments only and is not intended to be limiting of the present inventive concept. The term “or” refers to “and/or”. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical terms and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the present specification and the relevant art and should not be interpreted in an idealized sense unless expressly so defined herein. Furthermore, such terms should not be interpreted in an overly formal sense.

Embodiments are described herein with reference to cross section illustrations that are schematic illustrations of idealized embodiments. As such, variations from the illustrated shapes as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Furthermore, angles that are illustrated as being sharp may be rounded. Thus, the regions illustrated in the figures are schematic in nature and their shapes are not intended to illustrate the precise shape of a region and are not intended to limit the scope of the present claims.

Hereinbelow, through example embodiments, a ceramic catalytic filter and a method of preparing the same, and an air purification device including the ceramic catalytic filter may be described in greater detail.

### Nitrogen Oxide Decomposition Catalyst

A nitrogen oxide decomposition catalyst according to an embodiment is configured to catalyze a reaction to decompose nitrogen oxides into nitrogen and oxygen.

For example, the reaction that is catalyzed by the nitrogen oxide decomposition catalyst may be a reaction that decomposes nitrogen monoxide (NO) and/or nitrogen dioxide (NO₂) directly into nitrogen molecules (N₂) and oxygen molecules (O₂).

According to an embodiment, the reaction that decomposes nitrogen oxides into nitrogen and oxygen may be a reaction that directly decomposes nitrogen oxides into nitrogen and oxygen without a nitrogen oxide reducing agent.

According to an embodiment, the nitrogen oxide decomposition catalyst may not oxidize nitrogen oxides.

That is, the nitrogen oxide decomposition catalyst does not utilize an additional reducing agent and does not oxidize nitrogen oxides, and therefore may prevent the generation of secondary pollutants during the process of removing nitrogen oxides from the atmosphere. In this manner, the nitrogen oxide decomposition catalyst may be suitable for use in an air purification device and the like.

According to an embodiment, the nitrogen oxides may be gas-phase nitrogen monoxide (NO). That is, the nitrogen oxide decomposition catalyst may catalyze a reaction that directly decomposes gas-phase NO in the air.

According to an embodiment, the nitrogen oxide decomposition catalyst may be a thermal catalyst or a photo-thermal hybrid catalyst. That is, the nitrogen oxide decomposition catalyst may catalyze a reaction in the presence of thermal energy, or may catalyze a reaction in the presence of thermal energy and light energy.

According to an embodiment, the reaction that decomposes nitrogen oxides into nitrogen and oxygen may be carried out at a temperature of about 200° C. to about 500° C. For example, the reaction that decomposes nitrogen oxides into nitrogen and oxygen may be carried out at a temperature of about 300° C. to about 450° C. The aforementioned temperature ranges may be nitrogen oxide decomposition conditions of a relatively low temperature, and the nitrogen oxide decomposition catalyst as such may show excellent catalytic efficiency at a low temperature.

The nitrogen oxide decomposition catalyst according to an embodiment may include a heterogenous metal oxide and a first metal disposed on the heterogenous metal oxide.

According to an embodiment, the first metal may be platinum (Pt), palladium (Pd), rhodium (Rh), or a combination thereof.

For example, the first metal may be platinum.

According to an embodiment, an amount of the first metal with respect to 100 parts by weight of the nitrogen oxide decomposition catalyst may be about 0.1 parts by weight to about 30 parts by weight.

According to an embodiment, the heterogenous metal oxide may include a second metal and a third metal.

According to an embodiment, the second metal may be manganese (Mn), cobalt (Co), cerium (Ce), titanium (Ti), aluminum (AI), iron (Fe), nickel (Ni), sodium (Na), indium (In), bismuth (Bi), tungsten (W), tin (Sn), or a combination thereof. For example, the second metal may be Ti.

According to an embodiment, the third metal may be aluminum (Al), vanadium (V), cerium (Ce), or a combination thereof.

For example, the third metal may be Al or Ce.

According to an embodiment, the heterogenous metal oxide may be a compound represented by Formula 1:

Formula 1

Ti—M₁—Oₓ.

In Formula 1, M₁ may be a metal element, and x may be a real number greater than 0.

According to an embodiment, refer to the description with respect to the third metal for details of M₁.

According to an embodiment, M₁ may be aluminum (Al), vanadium (V), cerium (Ce), or a combination thereof.

For example, the heterogenous metal oxide may include Ti—Al—Oₓ, Ti—Ce—Oₓ, Ti—V—Oₓ, or a combination thereof.

According to an embodiment, the nitrogen oxide decomposition catalyst may be Pt-supported Ti—Al—Oₓ, Pt-supported Ti—Ce—Oₓ, Pt-supported Ti—V—Oₓ, or a combination thereof.

According to an embodiment, the composition of the third metal in the heterogenous metal oxide may be about 20 atomic percent (atom %) to about 60 atom % of the total atoms of the second metal and the third metal. For example, the composition of M₁ may be about 40 atom % to about 60 atom %, about 30 atom % to about 50 atom %, or about 45 atom % to about 55 atom %. Within the aforementioned ranges, the nitrogen oxide decomposition catalyst may have an improved efficiency.

According to an embodiment, the heterogenous metal oxide may be amorphous.

A nitrogen oxide decomposition catalyst according to an embodiment may show excellent nitrogen oxide decomposition performance by including an amorphous heterogenous metal oxide.

According to an embodiment, the heterogenous metal oxide may include a pore, and the first metal may be disposed in the pore.

According to an embodiment, the heterogenous metal oxide may have an average pore diameter of about 1 nanometer (nm) to about 50 nm. For example, the heterogenous metal oxide may have an average pore diameter of about 2 nm to about 40 nm, about 5 nm to about 30 nm, or about 10 nm to about 20 nm. Within the aforementioned ranges, the nitrogen oxide decomposition catalyst may have an improved efficiency.

According to an embodiment, the heterogenous metal oxide may have a surface area of 20 square meters per gram (m²/g) or greater. For example, the heterogenous metal oxide may have a surface area of about 20 m²/g to about 1,000 m²/g, about 30 m²/g to about 500 m²/g, or about 50 m²/g to about 300 m²/g.

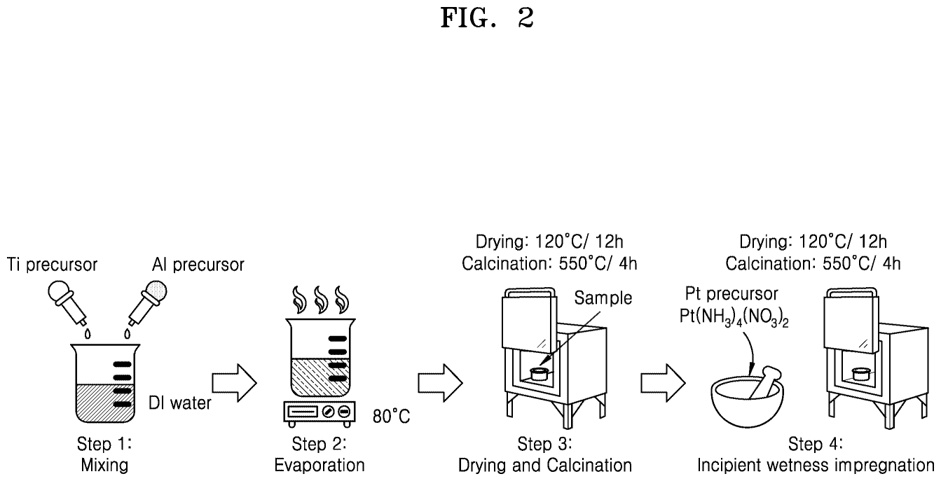

According to an embodiment, the nitrogen oxide decomposition catalyst may be prepared through a preparation method as illustrated in FIG. 2.

Referring to FIG. 2, the nitrogen oxide decomposition catalyst according to an embodiment may be synthesized through a process in which: first, a precursor including the second metal Ti and a precursor including the third metal Al are added to deionized water (DI) to produce a mixed solution, and the mixed solution is then subjected to heating and calcination to form a structure of a heterogenous metal oxide, followed by incipient wetness impregnation with Pt(NH₃)₄(NO₃)₂ as a precursor of the first metal Pt to provide an impregnated heterogenous metal oxide. After the incipient wetness impregnation with Pt(NH₃)₄(NO₃)₂, the impregnated heterogenous metal oxide can be heated to provide the nitrogen oxide decomposition catalyst.

FIG. 2 shows an example of a method of preparing a nitrogen oxide decomposition catalyst including Ti—Al—Oₓ as a heterogenous metal oxide and including Pt as a first metal. However; this example is provided only to assist in understanding a method of preparing a nitrogen oxide decomposition catalyst according to an embodiment; and the aforementioned preparation method is not limited thereto.

For example, a second metal precursor and a third metal precursor may be mixed with the solvent to form a mixed solvent, and if needed, a structural template may be further added. The structural template may provide the template when forming a support of a metal oxide, and for example, a neutral surfactant may be used. Examples of the neutral surfactant include Pluronic F108 and F127, triblock copolymers of polyethylene oxide/polypropylene oxide/polyethylene oxide (PEO/PPO/PEO), and the like.

The precursor of second metal and the precursor of third metal used in the preparation method above may be, for example, an alkoxide of a metal, a halide of a metal, a nitrate of a metal, hydrochloride of a metal, a sulfate of a metal, or an acetate of a metal. Without being limited to the aforementioned examples, any material capable of forming a metal oxide by calcination may be utilized. Such precursors of metals may be used in an amount of about 0.1 parts by weight to about 40 parts by weight based on 100 parts by weight of the solvent.

In the above preparation method, if necessary, the mixed solution may be agitated at room temperature for about 5 minutes to about 10 hours to ensure that each component is homogeneously formed.

The mixed solution thus obtained may be allowed to stand at room temperature and atmospheric pressure for about 1 hour to about 50 hours to evaporate volatile solvent components included in the mixed solution. The standing time is not limited to any particular duration, and any duration that allows the volatile solvent components to be evaporated may be sufficient. If necessary, the mixed solution may be heated to accelerate evaporation or the solvent may be removed under reduced pressure.

Once the solvent components are removed as described above, the product thus obtained may be further subjected to an aging process. This aging process, which is a process to increase the adhesion between atoms constituting the structure, may be carried out for about 6 hours to about 48 hours, at a temperature of about 30° C. to about 100° C.

Next, the product obtained from aging may undergo a calcination process by which a precursor of a second metal and a precursor of a third metal convert to an oxide form. This calcination process may be carried out with heating in the presence of oxygen. For example, the calcination process may be performed in atmospheric air, and at a temperature of about 300° C. to about 1,000° C., for example, about 400° C. to about 600° C., and for a duration of about 5 minutes to about 30 hours, for example, about 1 hour to about 10 hours.

Through this calcination process, the precursor of the second metal and the precursor of the third metal may convert to an oxide form. During this process, the metal oxides may form a porous support and later be able to support the first metal formed from the precursor of the first metal.

A nitrogen oxide decomposition catalyst according to an embodiment may be prepared at a reduced cost through the simple process as described above, and controlling a heterogenous metal oxide support, the size of first metal particles, and the like, may be performed by modification of the reaction conditions.

### Catalytic Reaction System

A catalytic reaction system according to an embodiment may include the nitrogen oxide decomposition catalyst.

According to an embodiment, the catalytic reaction system may not include a nitrogen oxide reducing agent. The nitrogen oxide reducing agent can comprise a reducing agent that is consumed in a stoichiometric amount to react with the NOx to provide reduced products (e.g., nitrogen and water). Examples of nitrogen oxide reducing agents include anhydrous ammonia, aqueous ammonia, urea, and so forth.

According to an embodiment, the catalytic reaction system may further include a thermal energy source or a photo-thermal hybrid energy source. The thermal energy source or the photo-thermal hybrid energy source may be disposed to supply an energy for activation of the nitrogen oxide decomposition catalyst.

The photo-thermal hybrid energy source may include a thermal energy source and a light energy source. The light energy source may be one that supplies light energy having a wavelength in the ultraviolet and visible light spectrum (e.g., 10 nm to 700 nm). For example, the energy source may be solar heat. The thermal energy source may be one that supplies infrared radiation [e.g., 780 nm to 1 millimeter (mm)] as thermal energy. The energy sources may include UV-LED. For example, the UV-LED may include UVA, UVB, or UVC.

### Air Purification Device

An air purification device according to an embodiment may include: the catalytic reaction system; and an energy source configured to supply energy for catalyst activation in a ceramic catalyst filter.

According to an embodiment, the energy source may be configured to supply light energy, electric energy, ion energy, thermal energy, or a combination thereof.

The light energy source may be one that supplies light energy having ultraviolet and visible light. For example, the energy source may be solar heat. The ion energy source may be one that supplies plasma. The thermal energy source may be one that supplies infrared radiation as thermal energy. The energy sources may include UV-LED. For example, the UV-LED may include UVA, UVB, or UVC.

According to an embodiment, the air purification device may be free of reducing agents. “Free” as used herein means that a nitrogen oxide reducing agent is excluded from the catalytic reaction system.

According to an embodiment, the air purification device may include a supply means for supplying air containing nitrogen oxides; and an air purification means for decomposing, thereby removing the nitrogen oxides from the air supplied from the supply means, wherein the air purification means may include a catalytic reaction system including the nitrogen oxide decomposition catalyst.

According to an embodiment, the air purification means may further include an analytical means for measuring the type and/or concentration of the nitrogen oxides.

Hereinafter, one or more embodiments will be described in greater detail with reference to the following examples. However, it will be understood that these examples are provided only to illustrate the inventive concept, and not intended to limit the scope of the present specification.

### EXAMPLES

### Preparation Example 1

Following the process as described in FIG. 2, a nitrogen oxide decomposition catalyst of Preparation Example 1 that includes Ti—Al—Oₓ and Pt supported thereon was prepared. The molar ratio of Ti to Al was 1:1, and the amount of the Pt supported was 5 wt %.

### Preparation Example 2

A nitrogen oxide decomposition catalyst of Preparation Example 2 was prepared following the same process as in Preparation Example 1, except that a Ce precursor was used instead of the Al precursor.

### Comparative Example 1

A nitrogen oxide decomposition catalyst of Comparative Example 1 was prepared following the same process as in Preparation Example 1, except that the Al precursor was not used.

### Evaluation Example 1: XRD Analysis

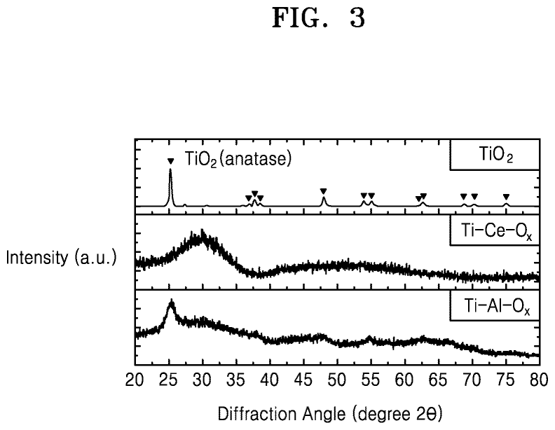

The nitrogen oxide decomposition catalysts of Preparation Examples 1 and 2 and Comparative Example 1 were each analyzed for crystallinity by X-ray diffraction (XRD) using CuKα radiation, and the XRD spectra are provided in FIG. 3.

As shown in FIG. 3, the nitrogen oxide decomposition catalysts of Preparation Example 1 (Ti—Al—Oₓ) and of Preparation Example 2 (Ti—Ce—Oₓ) had amorphous characteristics unlike the catalyst of Comparative Example 1 (TiO₂).

### Evaluation Example 2: NO Conversion Rate Evaluation

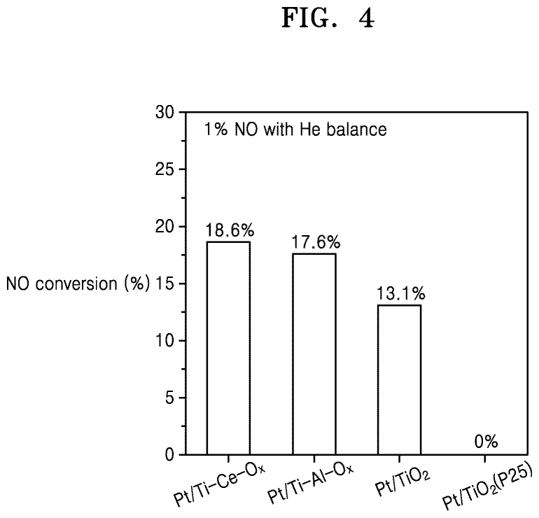

The nitrogen oxide decomposition catalysts of Preparation Example 1 [Pt/(Ti—Al—Oₓ)], Preparation Example 2 [Pt/(Ti—Ce—Oₓ)], Comparative Example 1 [Pt/(TiO₂)], and a commercially available Pt/TiO₂ catalyst (Pt/(TiO₂) P25) were each evaluated for NO conversion rate with a thermal energy source, and the results thereof are shown in FIG. 4. Specific evaluation conditions were as follows. Because the test gas was free of reducing agents, the evaluation was performed under thermal energy conditions that only allowed direct NO decomposition. The decomposition was performed in a He gas flow containing 1% NO gas at a space velocity of 30,000 per hour (h⁻¹), with 0.13 cubic centimeters (cc) of a catalyst. The decomposition temperature was 400° C.

As shown in FIG. 4, the nitrogen oxide decomposition catalysts according to embodiments have significantly superior NO decomposition efficiency under thermal conditions, compared with the catalysts of Comparative Examples 1 and 2.

### Evaluation Example 3: NO Conversion Rate Evaluation (2)

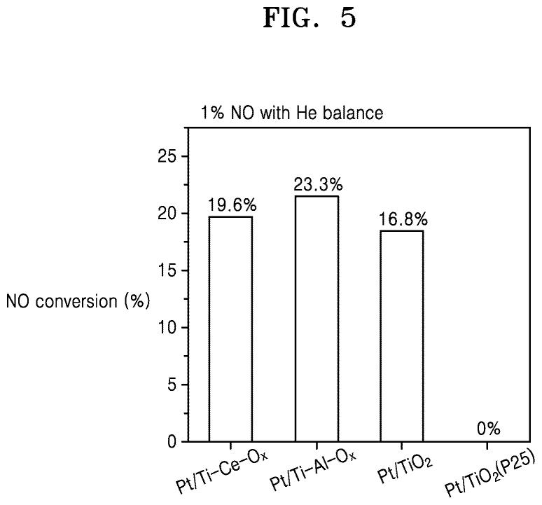

The nitrogen oxide decomposition catalysts of Preparation Examples 1 and 2 and Comparative Example 1, and a commercially available Pt/TiO₂ catalyst (“P25”) were each evaluated for NO conversion rate under a photo-thermal hybrid energy condition, and the results are provided in FIG. 5. Specific evaluation conditions were as follows. Because the test gas was free of reducing agents, the evaluation was performed under photo-thermal energy conditions that only allowed direct NO decomposition. The decomposition was performed in a He gas flow containing 1% NO gas at a space velocity of 30,000 h⁻¹, with 0.13 cc of a catalyst. The decomposition temperature was 400° C., and the optical density of the light source was 70 milliwatts per square centimeters (mW cm⁻²).

As shown in FIG. 5, the nitrogen oxide decomposition catalysts of Preparation Examples 1 and 2 had superior NO decomposition efficiency under photo-thermal conditions, compared with the catalysts of Comparative Examples 1 and 2.

### Evaluation Example 4: H₂-TPR Evaluation

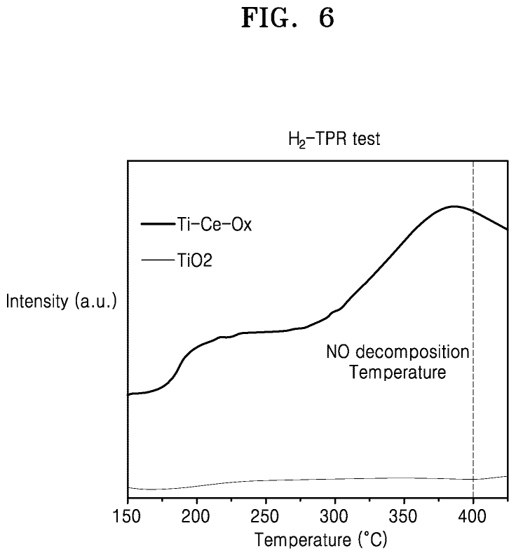

Using temperature-programmed desorption (TPD)/temperature-programmed reduction (H₂-TPR) equipment, by a temperature programmed reduction method (H₂-TPR), the nitrogen oxide decomposition catalysts of Preparation Example 2 and Comparative Example 1 were each analyzed for the distribution of catalyst reduction temperatures in accordance with temperature elevation under H₂ gas, and the degree of catalyst reduction depended on the amount of H₂ consumed. The results thereof are shown in FIG. 6.

Referring to FIG. 6, the nitrogen oxide decomposition catalyst of Preparation Example 2 had superior NO decomposition efficiency under thermal conditions, compared with the catalyst of Comparative Example 1.

Hereinbelow, an embodiment will be described in greater detail with reference to the accompanied drawings; however, the present inventive concept is not limited to these examples. While one or more embodiments have been described with reference to the figures, it will be understood by those of ordinary skill in the art that various changes in form and details may be made therein without departing from the spirit and scope of the disclosure as defined by the following claims.

The nitrogen oxide decomposition catalyst provides excellent nitrogen oxide decomposition performance. For example, the nitrogen oxide decomposition catalyst can catalyst a reaction to decompose nitrogen oxides in a gaseous phase without a reducing agent, and also without oxidation of reducing agents to pollutants.

Furthermore, a catalytic reaction system including the nitrogen oxide decomposition catalyst can provide high-efficiency nitrogen oxide decomposition in an environmentally-friendly manner, and the catalytic reaction system may be used in an air purification device.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A nitrogen oxide decomposition catalyst, comprising:
a heterogenous metal oxide and a first metal disposed on the heterogenous metal oxide,
wherein the nitrogen oxide decomposition catalyst is configured to catalyze a reaction to decompose nitrogen oxides into nitrogen and oxygen.

2. The nitrogen oxide decomposition catalyst of claim 1,
wherein the nitrogen oxide decomposition catalyst catalyzes a reaction that decomposes nitrogen oxides into nitrogen and oxygen without a nitrogen oxide reducing agent.

3. The nitrogen oxide decomposition catalyst of claim 1,
wherein the nitrogen oxide decomposition catalyst does not oxidize nitrogen oxides.

4. The nitrogen oxide decomposition catalyst of claim 1,
wherein the nitrogen oxides is gas-phase nitrogen monoxide.

5. The nitrogen oxide decomposition catalyst of claim 1,
wherein the nitrogen oxide decomposition catalyst is a thermal catalyst or a photo-thermal hybrid catalyst.

6. The nitrogen oxide decomposition catalyst of claim 1,
wherein the reaction to decompose nitrogen oxides into nitrogen and oxygen is performed at a temperature of about 200° C. to about 500° C.

7. The nitrogen oxide decomposition catalyst of claim 1,
wherein the first metal is platinum.

8. The nitrogen oxide decomposition catalyst of claim 1,
wherein an amount of the first metal per 100 parts by weight of the nitrogen oxide decomposition catalyst is about 0.1 parts by weight to about 30 parts by weight.

9. The nitrogen oxide decomposition catalyst of claim 1,
wherein the heterogenous metal oxide comprises a second metal and a third metal,
wherein the second metal is manganese, cobalt, cerium, titanium, aluminum, iron, nickel, sodium, indium, bismuth, tungsten, tin, or a combination thereof, and
the third metal is aluminum, vanadium, cerium, or a combination thereof.

10. The nitrogen oxide decomposition catalyst of claim 1,
wherein the heterogenous metal oxide is a compound represented by Formula 1:
Formula 1
Ti—M₁—Oₓ
wherein in Formula 1,
M₁ is a metal element, and
x is a real number greater than 0.

11. The nitrogen oxide decomposition catalyst of claim 10,
wherein M₁ is aluminum, vanadium, cerium, or a combination thereof.

12. The nitrogen oxide decomposition catalyst of claim 9,
wherein a composition of the third metal in the heterogenous metal oxide is about 20 atomic percent to about 60 atomic percent of the total atoms of the second metal and the third metal.

13. The nitrogen oxide decomposition catalyst of claim 1,
wherein the heterogenous metal oxide is amorphous.

14. The nitrogen oxide decomposition catalyst of claim 1,
wherein the heterogenous metal oxide has pores having an average pore diameter of about 1 nanometer to about 50 nanometer.

15. The nitrogen oxide decomposition catalyst of claim 1,
wherein the heterogenous metal oxide has a surface area of 20 square meters per gram or greater.

16. A catalytic reaction system comprising the nitrogen oxide decomposition catalyst of claim 1.

17. The catalytic reaction system of claim 16,
wherein the catalytic reaction system is free of a nitrogen oxide reducing agent.

18. The catalytic reaction system of claim 16,
further comprising a thermal energy source or a photo-thermal hybrid energy source.

19. The catalytic reaction system of claim 18,
wherein the photo-thermal hybrid energy source comprises the thermal energy source and a light energy source,
wherein the light energy source is solar energy.

20. An air purification device comprising the nitrogen oxide decomposition catalyst of claim 1.
